(19) United States
(12) Patent Application Publication
(10) Pub. No.: US 2005/0285526 A1
(43) Pub. Date: Dec. 29, 2005

(54) Optical filter for reducing duplicated images and plasma display panel employing the same

(76) Inventors: Dong-Gun Moon, Suwon-si (KR); Myun-Gi Shim, Suwon-si (KR); Jun-Kyu Cha, Suwon-si (KR); Ik-Chul Lim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/169,245

(22) Filed: Jun. 28, 2005

(30) Foreign Application Priority Data
Jun. 29, 2004 (KR) 10-2004-0049741

(51) Int. Cl. H01J 17/49

(52) U.S. Cl. 313/582

(57) ABSTRACT

Provided are an optical filter for reducing duplicated images and a plasma display panel employing the same. The optical filter includes a transparent substrate, a selective absorption layer deposited on a surface of the transparent substrate, an anti-reflection layer deposited on the selective absorption layer, an electromagnetic wave shield layer deposited on the other surface of the transparent substrate, and a duplicated image reducing layer deposited on the electromagnetic wave shield layer. When using the optical filter, external reflection and duplicated images can be reduced, thereby improving visual agreement and picture quality.

### CROSS-REFERENCE TO RELATED PATENT APPLICATION

This application claims the benefit of Korean Patent Application No. 10-2004-0049741, filed on Jun. 29, 2004, in the Korean Intellectual Property Office, the disclosure of which is incorporated herein in its entirety by reference.

### BACKGROUND OF THE INVENTION

1. Field of the Invention

The present embodiments relate to an optical filter for reducing duplicated images and a plasma display panel (PDP) employing the same. More particularly, the present embodiments relate to an optical filter that can reduce external reflection and duplicated images to improve visual agreement and picture quality and a PDP employing the same.

2. Description of the Related Art

A plasma display panel (PDP) is a thin light emitting type display device which can be more easily made large compared to other image display devices and is evaluated to have most proper properties for high quality digital televisions. However, the PDP has poor color purity due to electromagnetic waves generated by plasma emission and a circuit and unnecessary emission of near infrared rays by plasma of inert gas used for screen emission. Thus, to improve contrast and image quality and shield electromagnetic waves generated in a display, a filter is placed at a predetermined distance from a display surface.

FIGS. 1A and 1B are respectively a perspective view and a cross-sectional view of an optical filter generally used in a PDP. Referring to FIGS. 1A and 1B, a filter 100 is several mm distant from a PDP 110. The filter 100 includes a glass or transparent plastic substrate 103 for depositing films, an electromagnetic wave shield layer 104, a selective absorption layer 102 for improving color sensitivity and an anti-reflection layer 101. Electric charges of a conductive layer are grounded through a chassis 120 in the PDP 110.

Conventionally, a film coated with a plurality thin layers has been used as an optical filter for preventing reflection of external light and reducing diffused reflection which influences contrast. When using such a film, external light is reduced and clear images can be obtained.

However, even when the above film is applied, it is difficult to reduce external light to less than a certain level due to serious specular reflection on a filter surface. Duplicated images resulting from multiple reflections of a filter rear surface and a panel are formed on a panel surface, and thus picture quality is distorted and clear picture quality cannot be obtained.

### SUMMARY OF THE INVENTION

### The present embodiments provide an optical filter that can reduce external reflection and duplicated images to improve visual agreement and picture quality as well as a PDP employing the same.

According to the present embodiments, there is provided an optical filter including a transparent substrate, a selective absorption layer deposited on a surface of the transparent substrate, an anti-reflection layer deposited on the selective absorption layer, an electromagnetic wave shield layer deposited on the other surface of the transparent substrate, and a duplicated image reducing layer deposited on the electromagnetic wave shield layer.

The duplicated image reducing layer may be a reflection reducing layer or an anti-glare layer.

The duplicated image reducing layer may have a thickness of about 10 nm to about 100 μm.

The reflection reducing layer may be a single layer or a multi-layer composed of at least one material selected from the group consisting of TiO₂, SiO₂, Y₂O₃, MgF₂, Na₃AlF₆, Al₂O₃, Bi₂O₃, Gd₂O₃, LaF₃, PbTe, Sb₂O₃, SiO, SiN, Ta₂O₅, ZnS, ZnSe and ZrO₂.

The reflection reducing layer may have a specular reflectance of about 50% or less with respect to glass, a haze of about 40% or less and a transmittance of about 80% or greater.

The anti-glare layer may include a transparent resin and transparent particles.

The transparent resin may be at least one resin selected from the group consisting of acrylic resin, cellulosic resin, epoxy resin, urea melamine resin and urethane resin and the transparent particles may be at least one particle selected from the group consisting of styrene beads, melanin beads, acryl beads, acryl-styrene beads, polycarbonate beads, polyethylene beads, polyvinyl chloride beads, SiO₂ beads, Al—SiO₂ beads, and GeO₂ beads.

The transparent particles may have an average particle diameter of about 0.1 to about 20 μm.

The anti-glare layer may have a specular reflectance of about 50% or less with respect to glass and a transmittance of about 80% or greater.

According to another aspect of the present embodiment, there is provided a PDP employing the optical filter.

### BRIEF DESCRIPTION OF THE DRAWINGS

The above and other features and advantages of the present embodiment will become more apparent by describing in detail exemplary embodiments thereof with reference to the attached drawings in which:

FIGS. 1A and 1B are respectively a perspective view and a cross-sectional view of an optical filter commonly used in a conventional plasma display panel (PDP);

FIG. 2 is a schematic cross-sectional view of an optical filter according to a present embodiment;

FIG. 3 is a schematic perspective view of a PDP employing an optical filter according to a present embodiment;

FIG. 4 is a graph showing the transmittance with respect to wavelength in optical filters according to one of the present embodiments and conventional technology;

FIG. 5 is a graph showing the diffused reflectance on a filter front surface with respect to wavelength in optical filters according to the present embodiments and conventional technology;

FIG. 6 is a graph showing the rear surface reflectance on a filter front surface with respect to wavelength in optical filters according to the present embodiment and conventional technology;

FIG. 7 is a graph showing the front surface reflectance on a filter rear surface with respect to wavelength in optical filters according to the present embodiment and conventional technology; and

FIG. 8 is a graph showing the rear surface reflectance on a filter rear surface with respect to wavelength in optical filters according to the present embodiments and conventional technology.

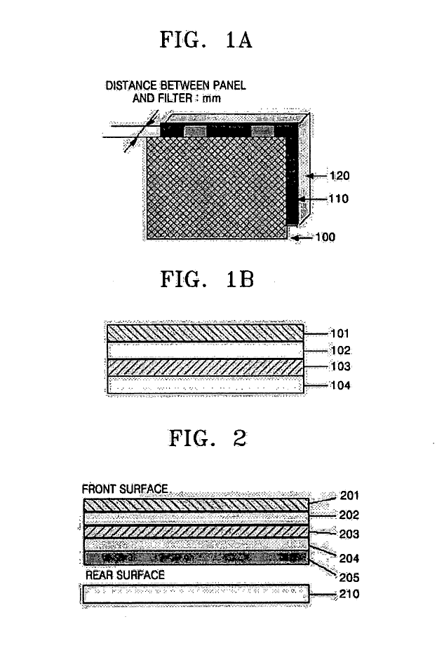

### DETAILED DESCRIPTION OF THE INVENTION

The present embodiment provides a novel optical filter for improving contrast and picture quality of a display and shielding electromagnetic waves generated in the display, which can improve duplicated images due to multiple reflections between the display and the filter and reduce a reflectance.

An optical filter according to the present embodiment includes a transparent substrate, a selective absorption layer deposited on a surface of the transparent substrate, an anti-reflection layer deposited on the selective absorption layer, an electromagnetic wave shield layer deposited on the other surface of the transparent substrate, and a duplicated image reducing layer deposited on the electromagnetic wave shield layer.

FIG. 2 is a schematic cross-sectional view of an optical filter according to one embodiment. Referring to FIG. 2, an optical filter according to another embodiment includes a transparent substrate 203, a selective absorption layer 202 deposited on a surface of the transparent substrate 203 using an adhesion layer, etc., and an electromagnetic wave shield layer 204 deposited on the other surface of the transparent substrate 203.

The transparent substrate 203 includes, but is not limited to, glass, polyethyleneterephthalate (PET) film, tri-acetyl-cellulose (TAC), polyvinylalcohol (PVA), polyethylene (PE), and the like, and the thickness thereof is generally about 10 μm to about 1000 μm. The adhesion layer may be formed using an adhesive such as acrylic resin, polyester resin, epoxy resin, urethane resin, and the like, and the thickness thereof is generally 1 to 100 μm.

The selective absorption layer 202 deposited on a surface of the transparent substrate 204 improves color reproducibility. The selective absorption layer 202 includes, but is not limited to, a chromophore such as tetraazaporphyrin compound, and the like. The thickness of the selective absorption layer 202 is generally about 1 to about 100 μm.

The electromagnetic wave shield layer 204 is deposited on the other surface of the transparent substrate 203 using an adhesion layer in a similar manner to the selective absorption layer 202. The electromagnetic wave shield layer 204 shields electromagnetic waves generated in a display. The electromagnetic wave shield layer 204 may be a metal mesh composed of Ag, Cu, Ni, Al, Au, Fe, In, Zn, Pt, Cr, Pd, etc., or a multi-layered thin film of these materials, but is not limited thereto. The multi-layered thin film has a thickness of about 10 to about 500 nm and the metal mesh has a thickness of about 1 to about 100 μm.

In the optical filter of the present embodiment, an anti-reflection layer 201 is deposited on the selective absorption layer 202. The anti-reflection layer 201 is also deposited using an adhesion layer in a similar manner to the selective absorption layer 202 and the electromagnetic wave shield layer 204. The anti-reflection layer 201 prevents the reflection of external light and reduces diffused reflection which influences contrast. The anti-reflection layer 201 is a single layer or a multi-layer of materials having different refractive indexes, such as TiO₂, SiO₂, Y₂O₃, MgF₂, Na₃AlF₆, and the like, and the thickness thereof is generally about 10 to about 100 nm.

The optical filter includes a duplicated image reducing layer 205 on the electromagnetic wave shield layer 204.

The optical filter of the present embodiment includes the duplicated image reducing layer 205, so that a specular reflectance on a filter front surface can be reduced to about 30% or greater compared to a conventional optical filter and a specular reflectance on a filter rear surface can be reduced to about 50% or greater compared to a conventional optical filter, and thus it has an excellent effect in the reduction in duplicated images which have a critical influence on the clearness of a screen.

The duplicated image reducing layer 205 may be a reflection reducing layer or an anti-glare layer and the thickness thereof may be about 10 nm to about 100 μm. When the thickness of the duplicated image reducing layer 205 is less than about 10 nm, it is difficult to reduce a reflectance. When the thickness of the duplicated image reducing layer 205 is greater than about 100 μm, it is difficult to deposit such a thick layer and, in a case of an anti-glare layer, a haze increases, thereby degrading clearness of an image.

Preferably, when the duplicated image reducing layer 205 is a reflection reducing layer, it may be a single layer or a multi-layer composed of at least one material selected from the group consisting of TiO₂, SiO₂, Y₂O₃, MgF₂, Na₃AlF₆, Al₂O₃, Bi₂O₃, Gd₂O₃, LaF₃, PbTe, Sb₂O₃, SiO, SiN, Ta₂O₅, ZnS, ZnSe and ZrO₂.

The reflection reducing layer can be formed in a general method in the art, for example, by coating, deposition, sputtering, and the like.

To effectively reduce duplicated images, the reflection reducing layer preferably has a specular reflectance of about 50% or less with respect to glass, a haze of about 40% or less and a transmittance of about 80% or greater.

When the duplicated image reducing layer 205 is an anti-glare layer, it includes a transparent resin and transparent particles.

The transparent resin may be at least one resin selected from the group consisting of acrylic resin, cellulosic resin, epoxy resin, urea melamine resin and urethane resin. The transparent particles may be at least one particle selected from the group consisting of styrene beads, melanin beads, acryl beads, acryl-styrene beads, polycarbonate beads, polyethylene beads, polyvinyl chloride beads, SiO₂ beads, Al—SiO₂ beads, and GeO₂ beads. The transparent particles on the anti-glare layer induce diffused reflection, thereby reducing the reflectance.

Preferably, the transparent particles have an average particle diameter of about 0.1 to about 20 μm. When the average particle diameter of the transparent particles is greater than about 20 μm, distortion of an image is serious and character readabililty is degraded. When the average particle diameter of the transparent particles is less than about 0.1 μm, sufficient effects of diffused reflection cannot be obtained.

To effectively reduce duplicated images, the anti-glare layer preferably has a specular reflectance of about 50% or less with respect to glass and a transmittance of about 80% or greater. The above elements are optionally combined with a rear surface 210.

A PDP according to another embodiment employs the optical filter of the previous embodiments.

One embodiment of the present PDP includes: a transparent front substrate; a rear substrate disposed in parallel to the front substrate; an optical filter for reducing duplicated imaged, disposed at a predetermined distance from the front substrate; a spacer dividing light emitting cells, disposed between the front substrate and the rear substrate; address electrodes extended along light emitting cells disposed in a direction and covered with a rear dielectric layer; a phosphor layer disposed in the light emitting cells; sustain electrode pairs extended so as to cross the address electrodes and covered with a front dielectric layer; and discharge gas in the light emitting cells.

The address electrodes are disposed between the rear substrate and the rear dielectric layer, the spacer is disposed on the rear dielectric layer, the sustain electrode pairs are disposed between the front substrate and the front dielectric layer, and the front dielectric layer may be covered with a protecting layer.

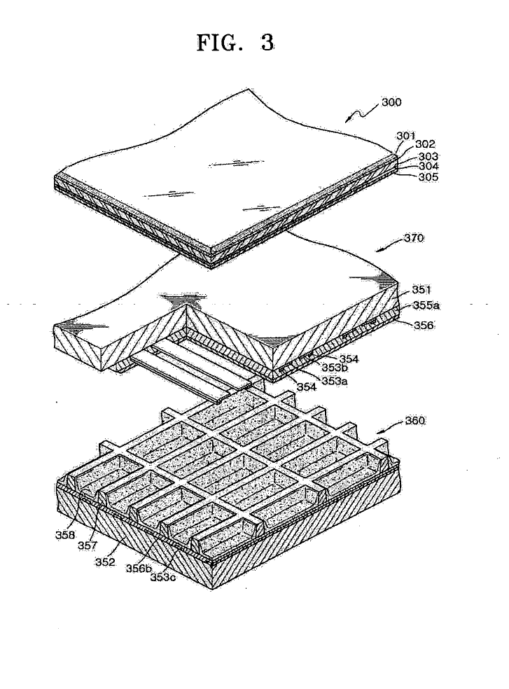

FIG. 3 is a partial perspective view of a PDP employing the optical filter for reducing duplicated images according to an embodiment.

Referring to FIG. 3, an optical filter 300 is disposed at a predetermined distance from a front panel 370 of a PDP, which includes the front panel 370 and a rear panel 360.

The optical filter 300 includes a duplicated image reducing layer 305, an electromagnetic wave shield layer 304, a transparent substrate 303, a selective absorption layer 302, and an anti-reflection layer 301, which are sequentially deposited from the front panel 370.

The front panel 370 includes a front substrate 351, sustain electrode pairs having Y electrodes and X electrodes formed on a rear surface of the front substrate, a front dielectric layer 355a covering the sustain electrode pairs, and a protecting layer 356 covering the front dielectric layer. Each of Y electrodes and X electrodes has transparent electrodes 353a and 353b composed of ITO and the like.; and a bus electrode 354 composed of a good conductive metal.

The rear panel 360 includes a rear substrate 352, address electrodes 353c formed on a front surface of the rear substrate so as to cross the sustain electrode pairs, a rear dielectric layer 356b covering the address electrodes, a spacer 357 formed on the rear dielectric layer to divide light emitting cells, and a phosphor layer 358 disposed in the light emitting cells.

The present embodiments will now be described in greater detail with reference to the following examples. The following examples are for illustrative purposes only and are not intended to limit the scope of the present embodiments.

### EXAMPLES

### Manufacturing of Optical Filter

### Example 1

A selective absorption layer coated with a porphyrin type dye was deposited on a 30 mm thick glass substrate as a transparent substrate using an acrylic resin as an adhesive. Mesh (line width 10 μm, pitch 300 μm) as an electromagnetic wave shield layer was deposited on the other surface of the glass substrate.

Then, a 100 μm anti-reflection film (manufactured by Japan Chemical Co., Ltd., an anti-reflection layer: 300 nm) was deposited on the selective absorption layer using the same adhesive as above, and the same film as the anti-reflection film was deposited as a duplicated image reducing layer on the electromagnetic wave shield layer to manufacture an optical filter.

### Example 2

An optical filter was manufactured in the same manner as in Example 1, except that a 100 μm thick anti-glare film (manufactured by Nippon Kayaku Co., Ltd.) was used instead of the anti-reflection film as the duplicated image reducing layer on the electromagnetic wave shield layer.

### Comparative Example

An optical filter according to conventional technology was manufactured in the same manner as in Example 1, except that an anti-reflection film was not deposited on an electromagnetic wave shield layer.

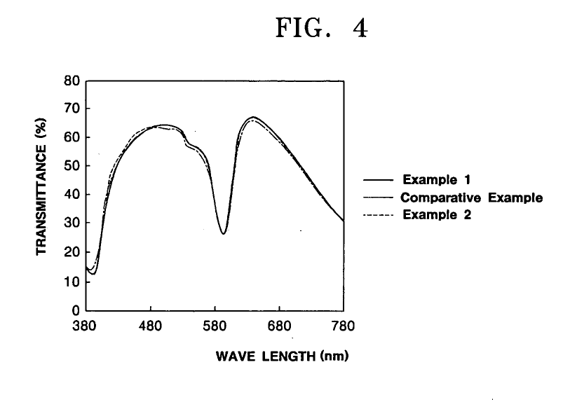

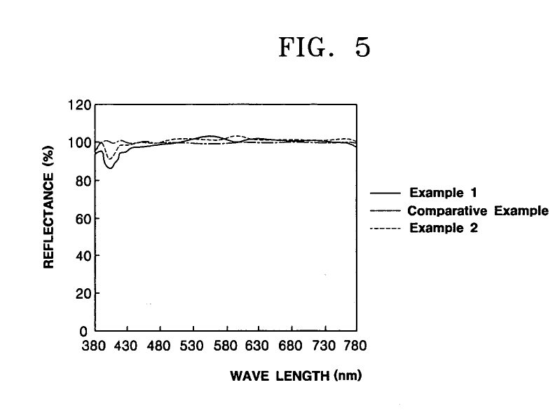

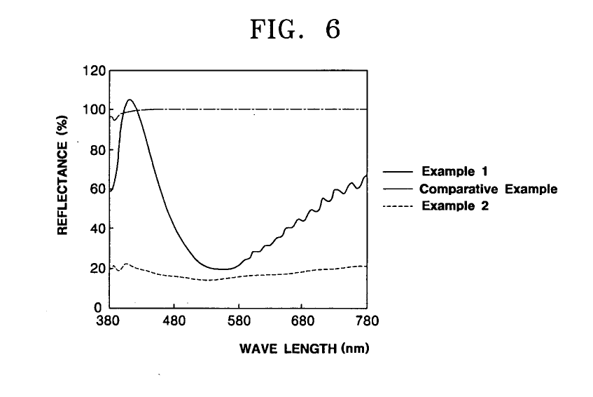

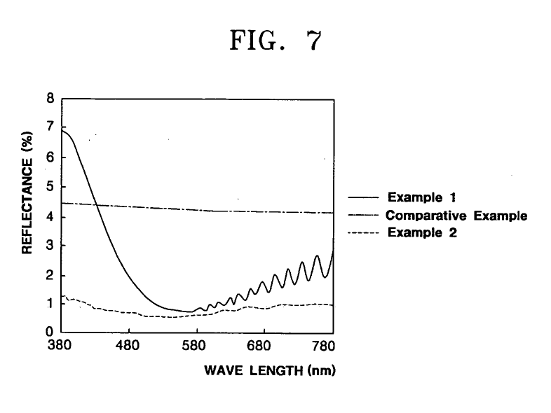

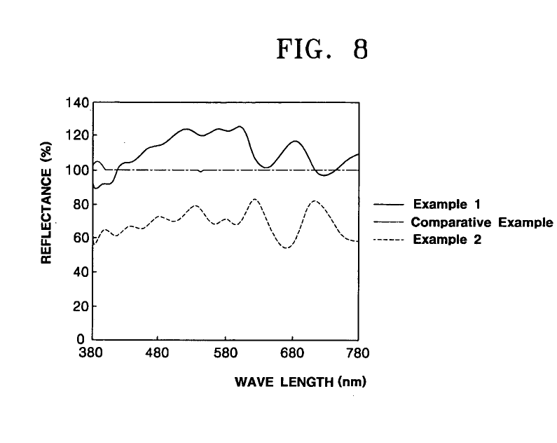

For optical filters manufactured in Examples 1 and 2 and Comparative Example, transmittance; diffused reflectance, front surface reflectance and rear surface reflectance on a filter front surface; and front surface reflectance and rear surface reflectance on a filter rear surface were measured. The obtained results so obtained are indicated in Table 1 and FIGS. 4 through 8.

TABLE 1

| | | Filter front surface | | | Filter rear surface | |
|---|---|---|---|---|---|---|
| | | | Front | Rear | Front | Rear |
| | Trans- | Diffused | surface | surface | surface | surface |
| | mittance | reflectance | reflectance | reflectance | reflectance | reflectance |
| | (%) | (%) | (%) | (%) | (%) | (%) |
| Example 1 | 50.39 | 99.46 | 100 | 47.9 | 51.95 | 110.39 |
| Example 2 | 50.76 | 100.77 | 100 | 17.65 | 37.75 | 68.8 |
| Comparative | 50.11 | 99.96 | 100 | 99.78 | 100 | 100 |
| Example | | | | | | |

As can be seen from Table 1 and FIGS. 4 through 8, the optical filter according to Example 1 insignificantly reduced the diffused reflectance, and reduced the specular reflectance (sum of front surface reflectance and rear surface reflectance) on the filter front surface by 25% and the specular reflectance on the filter rear surface by 20% compared to the optical filter according to Comparative Example. The optical filter according to Example 2 reduced the rear surface reflectance on the filter front surface by 30% or greater and the specular reflectance on the filter rear surface by 50% or greater compared to the optical filter according to Comparative Example, without increasing the diffused reflectance.

Thus, the optical filter according to some embodiments has an excellent effect in the reduction of duplicated images, which influence clearness of a screen, compared to the conventional optical filter.

According to the present embodiment, an optical filter that can reduce external reflection and duplicated images to improve visual agreement and picture quality and a PDP employing the same can be provided.

While the present embodiment has been particularly shown and described with reference to exemplary embodiments thereof, it will be understood by those of ordinary skill in the art that various changes in form and details may be made therein without departing from the spirit and scope of the present embodiments as defined by the following claims.

1. An optical filter comprising a transparent substrate, a selective absorption layer formed on a surface of the transparent substrate, an anti-reflection layer formed on the selective absorption layer, an electromagnetic wave shield layer formed on the other surface of the transparent substrate, and a duplicated image reducing layer formed on the electromagnetic wave shield layer.

2. The optical filter of claim 1, wherein the duplicated image reducing layer is a reflection reducing layer or an anti-glare layer.

3. The optical filter of claim 1, wherein the duplicated image reducing layer has a thickness of about 10 nm to about 100 μm.

4. The optical filter of claim 2, wherein the reflection reducing layer is a single layer or a multi-layer composed of at least one material selected from the group consisting of TiO₂, SiO₂, Y₂O₃, MgF₂, Na₃AlF₆, Al₂O₃, Bi₂O₃, Gd₂O₃, LaF₃, PbTe, Sb₂O₃, SiO, SiN, Ta₂O₅, ZnS, ZnSe and ZrO₂.

5. The optical filter of claim 2, wherein the reflection reducing layer has a specular reflectance of about 50% or less with respect to glass, a haze of about 40% or less and a transmittance of about 80% or greater.

6. The optical filter of claim 2, wherein the anti-glare layer comprises a transparent resin and transparent particles.

7. The optical filter of claim 6, wherein the transparent resin comprises at least one resin selected from the group consisting of acrylic resin, cellulosic resin, epoxy resin, urea melamine resin and urethane resin and the transparent particles comprise at least one particle selected from the group consisting of styrene beads, melanin beads, acryl beads, acryl-styrene beads, polycarbonate beads, polyethylene beads, polyvinyl chloride beads, SiO₂ beads, Al—SiO₂ beads, and GeO₂ beads.

8. The optical filter of claim 6, wherein the transparent particles have an average particle diameter of about 0.1 to about 20 μm.

9. The optical filter of claim 2, wherein the anti-glare layer has a specular reflectance of about 50% or less with respect to glass and a transmittance of about 80% or greater.

10. A plasma display panel employing the optical filter of claim 1.

11. The optical filter of claim 1, wherein the transparent substrate comprises glass, polyethyleneterephthalate (PET) film, tri-acetyl-cellulose (TAC), polyvinylalcohol (PVA) and polyethylene (PE), and wherein the thickness of the transparent substrate is about 10 μm to about 1000 μm.

12. The optical filter of claim 1, wherein the selective absorption layer comprises a chromophore and wherein the thickness of the selective absorption layer is about 1 μm to about 100 μm.

13. The optical filter of claim 12, wherein the chromosphere is a tetraazaporphyrin compound.

14. The optical filter of claim 1, wherein the electromagnetic wave shield layer comprises a metal mesh comprising one or more of Ag, Cu, Ni, Al, Au, Fe, ln, Zn, Pt, Cr, and Pd, and wherein the metal mesh has a thickness of about 1 μm to about 100 μm.

15. The optical filter of claim 1, wherein the electromagnetic wave shield layer comprises a multi-layered thin film comprising one or more of Ag, Cu, Ni, Al, Au, Fe, In, Zn, Pt, Cr, and Pd and wherein the multi-layered thin film has a thickness of about 10 nm to about 500 nm

16. The optical filter of claim 1, wherein the anti-reflection layer comprises a single layer, and wherein the thickness of the layer is about 10 nm to about 100 nm.

17. The optical filter of claim 1, wherein the anti-reflection layer comprises a multi-layer of materials with different refractive indexes, and wherein the thickness of the anti-reflection layer is about 10 to about 100 nm.

18. The optical filter of claim 17, wherein the multilayer of materials with different refractive indexes comprises one or more of TiO₂, SiO₂, Y₂O₃, MgF₂ and Na₃AlF₆.

19. The optical filter of claim 2, wherein the anti-glare layer has a specular reflectance of about 50% or less with respect to glass and a transmittance of about 80% or greater.
